(19) United States
(12) Patent Application Publication
(10) Pub. No.: US 2023/0082210 A1
(43) Pub. Date: Mar. 16, 2023

(54) HAPTIC VR SIMULATION DEVICE

(71) Applicant: VIRTUWALK B.V., Leusden (NL)

(72) Inventors: Leonardus Clemens Maria WENNEKES, Leusden (NL); Franciscus Jitte Maria NIEUWENHUIS,ir., Amerongen (NL)

(21) Appl. No.: 17/795,464

(22) PCT Filed: Jan. 11, 2021
(86) PCT No.: PCT/NL2021/050012

§ 371 Date: Jul. 26, 2022

(30) Foreign Application Priority Data
Apr. 4, 2020 (NL) 1043556

(51) Int. Cl. A63B 71/06; A63B 22/02; G06F 3/01

(52) U.S. Cl. CPC A63B 71/0622; A63B 22/025; G06F 3/011; A63B 2071/0638; A63B 2071/0666; A63B 2071/0675; A63B 2220/16

(57) ABSTRACT

Haptic simulation device that allows a user, by means of natural body movements, to move through a virtual environment displayed by a VR control system (1) and display means (2), using a treadmill with a unidirectional (5) movable miming deck (6). The detection means comprise a control member (7) with a shape such, that the control member extends in front of and/or at least partly to the side of the user, during use of the device when the user is on the treadmill. The control member is coupled to a rotational pressure sensor (8) and one or more transverse pressure sensors (10). The rotational and transverse pressure sensors are coupled to the VR control system and the treadmill control system such that (a) if the user exerts forward or rearward pressure to the control member, the running deck moves rearward and forward, respectively, and (b) if the user additionally exerts a rotational pressure and/or a transverse pressure on the control member, the VR control system moves the virtual environment displayed in the VR display

The invention relates to a haptic VR simulation device for a user, with which the user can move, by walking or cycling, through a virtual environment displayed by Virtual Reality (VR) display means.

The object of the present invention is to provide an improved simulation device, in particular—but not exclusively—for the purpose of study and/or rehabilitation of walking movements and, optionally, bicycle movements.

To this end, according to the invention, a device is provided which is intended and arranged as a haptic VR simulation device for a user, with which the user, under the control of natural or nature-identical body movements and/or displacement of the body weight, as detected by detection means, is able to displace, walking or cycling, on a treadmill through a virtual environment as displayed by a VR control system and VR display means, the treadmill having a physically movable unidirectional running deck, powered by running deck drive means, under the control of a treadmill control system, wherein the detection means comprises a control member provided with functionally and essentially such a shape, for example of a horizontal (recumbent) U, that in use of the device when the user is located on the running deck of the treadmill, the control member is extending in front of and/or at least partially to the side of the user,

wherein the control member is coupled to a rotational pressure sensor arranged for detecting rotational pressure on the control member counter clockwise or clockwise around a substantially vertical axis of rotation of the control member, and wherein the control member is coupled to one or more transverse pressure sensors, which are arranged to detect transverse pressure on the control member forward or rearward and/or in other directions transverse to the substantially vertical axis of rotation of the control member,

wherein the rotational pressure sensor and one or more transverse pressure sensors, for example by means of a simulation control system, are coupled to the VR control system and the treadmill control system, all this arranged in such a way that
if the user exerts a pressure forward or rearward on the control member, the running deck is moved rearward or forward, respectively, by an amount depending on the amount of pressure exerted to the control member;
if the user additionally (to a forward or rearward pressure) exerts on the control member a rotational pressure, and/or a transverse pressure to the right or to the left, the VR control system moves the virtual environment displayed in the VR display means to the left or the right, respectively, by an amount depending on the amount of pressure applied to the control member.

Preferably, the simulation control system is arranged such that
if the user exerts a forward or rearward pressure on the control member, the VR control system moves the virtual environment displayed in the VR display means slightly upward or downward by an amount depending on the amount of pressure applied to the control member;

and/or
if the user additionally (to a forward or rearward pressure) exerts on the control member a rotational pressure, and/or a transverse pressure to the right or to the left, the VR control system slightly tilts the virtual environment displayed in the VR display means to the left or to the right, respectively by an amount depending on the amount of pressure applied to the control member.

In summary, the invention comprises a treadmill combined with a VR head set, creating the illusion that a user can actually walk interactively through a (virtual) space (optionally cycle). This is done by moving the image (shown to the user via the, for example, VR headset) from the VR control system under the influence of input from an intuitive control member operated by the user.

During use of the device, the user stands on the running deck of the treadmill and thereby holds or at least touches the control member. The forces (pressure directions) on this control member are detected and these actions of the user control the treadmill and/or the VR image. The speed of the running deck is fairly consistent with the movement of the VR image in the VR headset.

If the user wants to walk forward, he is able to do so. The standard consequence thereof is, that the user exerts some degree of forward force on the control member. The control member is fixed on the treadmill and the user steps forward on the running deck. However, the treadmill control system is linked to the force measured in the control member and the running deck will start moving. At the same time and at the same speed, the VR image will move rearward. This combination creates the illusion that the user is walking forward.

The same logic is applied to turn around: the control member also measures the transverse force and/or the rotational torque on the control member about the vertical axis of the control member.

An adjustable combination (preferably) of the sideways exerted force and/or the torque on the control member provides for turning the world in the VR headset. This creates for the user in the VR image the illusion of being rotated. Since the control member itself does not actually rotate or at least rotates to a little extent, the user is not aware (is not aware of this) that his legs, which walk on the running deck, are not turning. Use is being made of this observation in the device according to the invention. Due to the combination of walking forward and turning, the user has the illusion of actually walking through a virtual world.

The VR system itself incorporates the behaviour, that if the user only turns its head, a corresponding part of the VR image is displayed. This gives the illusion that the user is simply walking straight ahead, and solely turning its head. Only when the control member is pressed to the side and/or is loaded with a rotational torque, the VR world turns. The illusion is equal to that of pushing a shopping cart through a supermarket: it must also be actively turned by the user's hands.

The invention will now be discussed in more detail with reference to the figure description below.

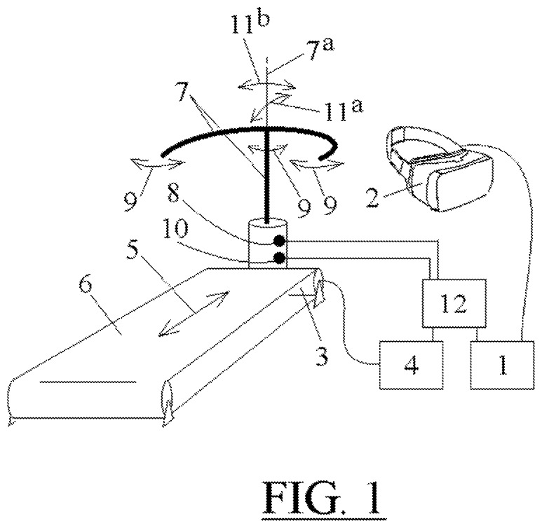

FIG. 1 schematically shows an exemplary embodiment of a device according to the invention.

FIG. 1 schematically shows an exemplary embodiment of a device according to the invention, which is intended and arranged as a haptic VR simulation device for a user (not shown) with which the user, under the control of natural or nature-identical body movements and/or displacement of the body weight, detectable by detection means, is displacing, walking or cycling, through a virtual environment displayed by a VR control system 1 and VR display means 2 using a treadmill with a unidirectional 5 running deck 6, which is physically displaceable by means of running deck driving means 3, under the control of a treadmill control system 4.

The detection means for detecting natural or nature-identical body movements and/or displacement of the body weight of the user, when the user is moving, walking or cycling, through a virtual environment displayed by the VR control system 1, comprise a control member 7, which is functionally and essentially provided with such a shape, for example of a horizontally oriented U, that the control member extends in front of and/or at least partly to the side of the user when the user is positioned on the running deck 6 of the treadmill, during use of the device.

The control member 7 is coupled to a rotational pressure sensor 8 (in the present application, the terms “pressure” and “force” are considered and defined as identical), which is adapted to detect rotational pressure, represented by the arrows 9, on the control member counter clockwise or clockwise around a substantially vertical axis of rotation 7a of the control member 7. The control member 7 is also coupled to one or more transverse pressure sensors 10, which are arranged to detect transverse pressure, represented by the arrows 11, on the control member 7 forward or rearward 11a and/or in other directions 11b transverse to the essentially vertical axis of rotation 7a of the control member 7.

The rotational pressure sensor 8 and the one or more transverse pressure sensors 10 are coupled to the VR control system 1 and the treadmill control system 4, for example by means of a simulation control system 12.

All this is arranged with hardware and software such that
if the user exerts a forward or rearward pressure 11a on the control member 7, the running deck 6 is moved rearward or forward 5, respectively, by an amount depending on the amount of pressure exerted to the control member;
if the user additionally (to a forward or rearward pressure) exerts on the control member 7 a rotational pressure 9, and/or a transverse pressure 11b to the right or to the left, the VR control system 1 moves the virtual environment displayed in the VR display means 2 to the left or to the right respectively by an amount which depends on the degree of the pressure exerted on the control member 7.

Moreover—optionally—a feature is provided with which, if the user exerts a forward or rearward pressure 11a on the control member 7, the VR control system 1 moves the virtual environment shown in the VR display means 2 slightly upward or downward, respectively by an amount depending on the amount of pressure exerted to the control member. Furthermore—also optionally—a feature is provided with which, if the user
in addition to a forward or rearward pressure 11a—exerts a rotational pressure 9 on the control member 7, and/or a transverse pressure 11b to the right or to the left, the

VR control system 1 will tilt the virtual environment in the VR display means 2 slightly to the left or to the right, respectively by an amount depending on the amount of pressure applied to the control member.

Hence, the present invention provides an improved simulation device for the purpose of study, experience and/or rehabilitation, etcetera of walking movements and optionally cycling movements.

1. Device intended and arranged as a haptic VR simulation device for a user, with which the user, under the control of natural or nature-identical body movements and/or displacement of the body weight, as detected by detection means, is able to displace, walking or cycling, on a treadmill through a virtual environment as displayed by a VR control system and VR display means, the treadmill having a physically movable unidirectional running deck, powered by running deck drive means, under the control of a treadmill control system,
wherein the detection means comprises a control member, which is functionally and essentially provided with such a shape, for example of a recumbent U, that in use of the device when the user is located on the running deck, the control member extends in front of the user and/or at least partly to the side of the user,
wherein the control member is coupled to a rotational pressure sensor, which is arranged for detecting the rotational pressure on the control member counter clockwise or clockwise around a substantially vertical axis of rotation of the control member, and wherein the control member is coupled to one or more transverse pressure sensors, which are arranged to detect transverse pressure on the control member forward or rearward and/or in other directions, transverse to the essentially vertical axis of rotation of the control member,
wherein the rotational pressure sensors and one or more transverse pressure sensors, for example by means of a simulation control system, are coupled to the VR control system and to the treadmill control system, all this arranged in such a way that
if the user exerts a forward or rearward pressure on the control member, the running deck is moved rearward or forward, respectively, by an amount depending on the amount of pressure applied to the control member;
if the user additionally exerts on the control member a rotational pressure, and/or a transverse pressure to the right or to the left, the VR control system moves the virtual environment displayed in the VR display means to the left or to the right, respectively, by an amount depending on the amount of pressure applied to the control member.

2. Device according to claim 1, wherein, if the user exerts a forward or rearward pressure on the control member, the VR control system moves the virtual environment displayed in the VR display means slightly upward or downward, respectively, by an amount depending on the amount of pressure applied to the control member.

3. The device according to claim 1 wherein, if the user exerts on the control member a rotational pressure, and/or a transverse pressure to the right or to the left, the VR control system tilts the virtual environment displayed in the VR display means slightly to the left or the right, respectively, by an amount depending on the amount of pressure applied to the control member.
